(19) United States
(12) Patent Application Publication
(10) Pub. No.: US 2018/0097748 A1
(43) Pub. Date: Apr. 5, 2018

(54) Partitioned Topic Based Queue with Automatic Processing Scaling

(71) Applicant: Microsoft Technology Licensing, LLC, Redmond, WA (US)

(72) Inventor: Mihai Bogdan Pienescu, Redmond, WA (US)

(21) Appl. No.: 15/282,281

(22) Filed: Sep. 30, 2016

(51) Int. Cl. H04L 12/861; H04L 12/58; G06F 17/30

(52) U.S. Cl. CPC H04L 49/90; G06F 17/30598; H04L 51/22

(57) ABSTRACT

Managing queue message processors is illustrated. Messages are partitioned in a queue into topic partitions. The topic partitions are defined by partition topic identifiers derived from data or metadata for the messages. Messages in the queue are assigned to message processors, in a set of message processors. The messages are assigned such that, absent changes to the set of message processors, messages in a given partition are assigned to the same message processor. The length of the queue is evaluated. The set of message processors is scaled based on the length of the queue.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cluster” computing systems, such as cloud computing system, on-premises cluster computing systems, and the like. In this description, “cluster computing” may be systems or resources for enabling, convenient, on-demand network access to a shared pool of configurable computing resources (e.g., networks, servers, storage, applications, services, etc.) that can be provisioned and released with reduced management effort or service provider interaction.

Often, cluster based systems are configured to perform various tasks for users of the cluster based systems, for example, tenants or subscribers to a cloud based system. These tasks are prioritized and performed based on the tasks being pushed onto, and popped off of one or more queues. The cluster based systems need to have sufficient processing capabilities to process items on the queues. It can be difficult to have sufficient processing capabilities for the queues without having an unacceptable excess of processing capabilities resulting in wasted computing resources. Thus, there is a fine balance between having sufficient message processing capabilities and excessive processing capabilities.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Managing queue message processors is illustrated. Messages are partitioned in a queue into topic partitions. The topic partitions are defined by partition topic identifiers derived from data or metadata for the messages. Messages in the queue are assigned to message processors, in a set of message processors. The messages are assigned such that, absent changes to the set of message processors, messages in a given partition are assigned to the same message processor. The length of the queue is evaluated. The set of message processors is scaled based on the length of the queue.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a system including a plurality of queues that are partitioned into topic partitions; and

FIG. 2 illustrates a method of managing queue message processors.

### DETAILED DESCRIPTION

Embodiments illustrated herein include a system for queue message handling. In particular, queues may be implemented on a queue domain basis. Messages to be processed may include queue domain metadata that defines what queue a message will be pushed onto. Each queue may be partitioned within the queue into partitions where each partition is determined by a partition topic identifier.

For example, a queue may be implemented for a queue domain, such as ‘product inventory’ (or virtually any other topic). In an alternative example, in a multi-tenant environment, each queue may be for a given tenant, and thus the queue domain may be a tenant identified by a tenant identifier.

A given queue may be further partitioned into different partitions based on partition topic identifiers. Some embodiments may divide messages into partitions based on content partition topic identifiers. Specifically, a content partition topic identifier is based on content of a message to be processed or content of metadata associated with a message as opposed to a type of processing that should be performed on the message.

Further, if a given message includes task metadata indicating computing tasks to be performed on the message, that particular metadata is excluded from the data that may be used to define a content partition topic identifier as used herein.

Illustrating now an example, a message may be a product inventory message that needs to be processed for a book. In this example, the queue domain may be product inventory and the partition topic identifier may be named ‘book’. The term ‘book’ may be associated in metadata with a particular message. Note that in some embodiments, the partition topic identifier may be based on some derived identifier. For example, a hash of the term ‘books’ may be used as a partition topic identifier.

Alternatively or additionally, a derived identifier naming a partition topic identifier may be derived by a process that includes various inferences. For example, consider a case where a product inventory message is to be processed for a teddy bear. The term ‘stuffed animals’ may be derived from ‘teddy bear’. This derived term could be used as the name for the partition topic identifier for a product inventory operation for a teddy bear. Alternatively and additionally, the derived term ‘stuffed animals’ could be hashed to create a different identifier, which would then be used as the name for the partition topic identifier. Hashing has several advantages, including the ability to spread topics randomly, to genericize topic names, and in some embodiments, as illustrated below, to assign message processors to topic partitions.

Thus, in some embodiments, a queue domain identifier is derived from and/or defined in metadata for messages where the queue domain identifier can be used to identify a queue for the message. A given queue is partitioned into topic partitions based on partition topic identifiers. The topic partitions are defined by additional data in the messages or metadata associated with the messages.

Message processors process messages on the queue.

An instance processor manager may be configured to evaluate, for each queue, the length of the queue. The length of the queue is the number of unprocessed messages on the queue. When the length of the queue exceeds an upper limit threshold, then the instance processor manager scales up the number of message processors to handle a load for the unprocessed messages for a particular queue. In some situations, this may include simply adding additional message processors dedicated to a queue from an existing virtual machine. However, in other situations, additional new virtual machines may need to be initialized to add additional message processors dedicated to a particular queue. When the length of a given queue is below a lower limit threshold, then the instance processor manager can scale the number of message processors down by removing message processors for the queue. Additionally, if machines can be removed from the system to conserve resources, this can be done as well.

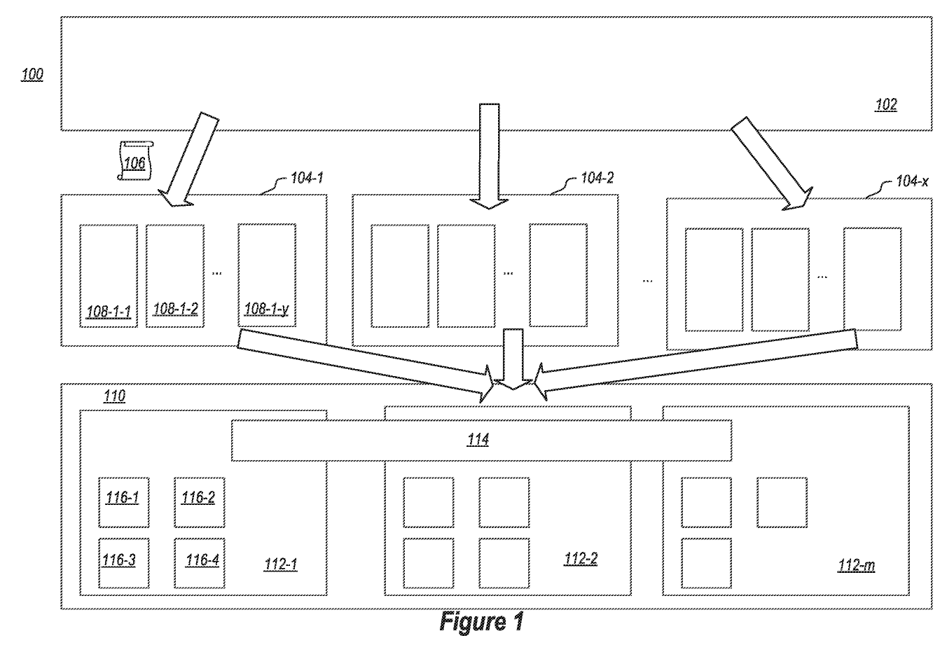

Referring now to FIG. 1, an example operating environment 100 is illustrated. FIG. 1 illustrates a front end 102. The front end 102 may be, for example, a web interface or other front end interface configured to receive user input. The front end 102 may alternatively or additionally include logic configured to execute operation rules. For example, the front end may be an order system for an e-commerce web site. The front end 102 may be another type of data input and/or processing entity. A front end 102 generates messages to be pushed onto queues, such as the queues 104-1 through 104-x. For example, FIG. 1 illustrates a message 106 produced by the front end 102.

The message 106 has a particular queue domain associated with it and will therefore be placed on a particular queue based on the queue domain. For example, one queue may be configured to handle order processing, while another queue is configured to handle inventory management. A given queue domain for a message will define onto which queue a message is pushed. The queue domain may be included in a queue domain identifier in metadata for the message 106.

Each queue further includes a number of topic partitions. For example, queue 104-1 includes topic partitions 108-1-1, 108-1-2 through 108-1-y. The other illustrated queues also include topic partitions as shown in FIG. 1. The topic partitions may be content based partitions. That is, each topic partition is based on some expected content based metadata or data associated with messages. Note that content based metadata and data is metadata and data that describes things and not actions associated with the message.

Thus, messages may placed onto queues based on a queue domain identifier included in, or derived from metadata for the messages and into topic partitions in a queue based on partition topic identifiers, based on or derived from metadata or data associated with the messages. The set of partition topic identifiers, and thus topic partitions (where there is a topic partition in the queue for each partition topic identifier) for a queue is dynamic and may change over time. Indeed, the set of partition topic identifiers, and thus topic partitions for a queue will often increase and decrease, roughly, in proportion to the length of the queue. Although, in other embodiments, partition topic identifiers may increase at a different rate than the length of the queue. In these cases, more complex evaluations may be performed to determine if additional message processors should be assigned to a queue or be unassigned from a queue.

FIG. 1 further illustrates a backend 110. The backend 110 includes a number of message processors in machines. The message processors are configured to process message from a queue. In some embodiments, the system is configured such that messages from a given topic partition on a given queue will only be processed by a single message processor, absent some change to a set of message processors assigned to a queue.

Illustratively,the backend 110 includes a plurality of machines 112-1 through 112-m. The machines 112-1 through 112-m may be virtual machines implemented in a cluster computing system. The backend includes an instance processor manager 114, which, in the illustrated example, is a distributed component that is distributed across the machines in the backend 110. Although the instance processor manager may be implemented in other fashions in other embodiments. The instance processor manager 114 creates and deletes message processors, assigns message processors to queues, and assigns messages to message processors. For simplicity of explanation, the description herein focusses on message processors 116-1 through 116-4 on machine 112-1, although it should be appreciated that the other machines illustrated may also include message processors.

Each message processor can process messages from any of the queues, but will be assigned to a particular queue. Note that different message processors on the same machine can process messages from the same, or different queues. Further, message processors on different machines, may nonetheless process messages from the same queue. Thus, machine affinity is not necessarily definitive of queues that a message processor will service.

Using this infrastructure, embodiments can scale up (or scale down) message processors and/or machines as needed. For example, in the illustrated embodiment, an instance message processor, such the instance message processor 114 can query a queue, such as queue 104-1, to determine the length of the queue. Depending on the length of the queue (and potentially alternative or additional factors), the instance message processor 114 may choose to add additional message processors assigned for the queue 104-1 or to remove message processors from being assigned to the queue 104-1.

Additionally, additional machines can be added to the backend 110 to add additional messages processors for a particular queue if needed.

The following illustrates one example process of assigning message processors to topic partitions.

Messages are assigned to various topic partitions in a queue based on partition topic identifiers. Embodiments may be implemented where messages in a topic partition are to be processed in a First In First Out (FIFO) order. To accomplish this, a single message processor processes all messages for a given topic partition (except in limited circumstances when the number of message processors and/or machines are changed as illustrated in more detail below) At any given moment the backend 110 has, for a queue a number of message processors.

In some embodiments, message processors on any machine can be assigned to any queue and any topic partition within a queue.

In other embodiments, a particular machine may be specific to a particular queue. All messages processors on that particular machine will process messages from the same queue. This may be done for security or other reasons.

Assume that for a given queue, there are a given number i of message processors.

In the following illustrated example, processors will be assigned to process topic partitions from a given queue based on a hash key of a partition topic identifier name, modulo the total number of message processors. For example, each message processor is assigned a number from 0 to J-1 where there are a total of j processors. A partition topic identifier name is hashed and divided by the total number of message processors, j for the queue which includes the topic partition. The remainder of this division(i.e., the result of a modulo operation)is used to select a message processor to process the partition topic identifier.

For example, assume a total of j processors for a set of processors for a queue 104-1. Also assume that partition topic identifier names (such as ‘books’ in the example above) for topic partitions can be hashed resulting in a hash key represented by TopicNameHashKey. For a given topic partition (e.g., partition 108-1-1), TopicNameHashKey modulo j identifies the message processor, from among the set of message processors assigned to the queue to process messages for the given topic partition.

Thus, for example, in an embodiment where 6 message processors are allocated, the 5^{th} message processor (where message processors are from 0 to 5) will process any messages where for a topic partition, TopicNameHashKey modulo 6=5, the 4^{th} message processor will process any messages where for a topic partition, ConteritTopicNameHashKey modulo 6=4, the 3rd message processor will process any messages where for a topic partition, ContentTopicNameHashKey modulo 6=3, the 2^{nd} message processor will process any messages where for a topic partition, ContentTopicNameHashKey modulo 6=2, the 1^{st} message processor will process any messages where for a topic partition, ContentTopicNameHashKey modulo 6=1, and the 0^{th} message processor will process any messages where for a topic partition, ContentTopicNameHashKey modulo 6=0. Message processors retrieve messages from the queue. Message processors that are not assigned to a given message (because an identifier for the message does not match the result of the modulo) will simply ignore that message.

In this way different message processors will generally not process messages from the same partition. However, overlap of message processor assigned to a topic partition may happen when the system scales up or down the number of message processors for a queue and/or when the number of backend machines changes. In particular, the result of the modulo will change resulting in change in assigned message processors.

In these situations a locking strategy can be implemented for the messages in the queue. In particular, embodiments may lock a partition within a queue.

For example, the queue may be implemented with entries having the following characteristics:

Partition key: queue name

Row key: [N|I|P|F]_timestamp_guid. Prefixes as follows: N: new, I: in progress, P: processed, F: failed

Note that because the rowkey is prefixed by a timestamp, reading from a partition in the queue can be configured to always return the oldest entries first.

Locking a topic is done via inserting a “Lock” entity under the same partition key. Thus, for example, for a new message, the following information is added to the queue:

Partition key: E-sales

Row Key: N_9-28-2016-23:38:34_367859

Topic: books

To lock the ‘books’ partition, the following entries may be made into the queue:

Partition key: E-sales

Row Key:

Row 1: L_books

Row 2: Key: I_9-28-2016-23:38:37_367859_{—}

L_signifies a lock on a topic identifier. Once the lock is placed on a topic partition, the processor will be able to move all the messages for that topic partition to the various states described above. This lock entry has a time to live. This can be used, for example, where message processors crash or are delayed caused by a machine crash or other event. Thus, a message processor will check the lock information in the queue in conjunction with retrieving a message to process from a topic partition and when processing has completed for a message.

When a message processor attempts to retrieve a message from a topic partition, the message processor will check the lock information in the queue to determine if the topic partition is already locked, in this case, determine if the lock information includes a state of “In process” for the topic partition. If the topic partition is locked, the message processor will not retrieve the message for processing. This means that a different message processor is processing the message, this can be due to a change in the number of message processors assigned to a queue and/or machine. If the other message processor fails or is delayed, the lock will expire such that the lock will no longer be valid and a message processor can retrieve the message.

When a message processor returns a result from processing, if the lock information indicates that the topic is in a state of ‘New’ or ‘Processed’, this indicates that another message processor has already processed the message and the result should be discarded. If the lock information has an entry of ‘In progress’ or ‘Failed’, the result can be returned and the lock information can be updated to update the topic partition to ‘Processed’, A message processor can also update the lock information with ‘In progress’ when a message is retrieved from the queue for the topic partition.

Locking operations on the lock information are executed in a transaction so that the queue is in a consistent state.

Embodiments may implement automatic scale-up and scale-down of message processors. The following illustrates an example of how automatic scale-up and scale-down can be accomplished when topics increase and decrease in approximate proportion to increases and decreases in queue length.

In this illustrated example, each queue is associated with the following parameters that control the automatic scale up/down of the number of message processors for a given queue:
min message processors per instance—The minimum number of message processors that can be assigned to a queue.
max message processors per instance—The maximum number of message processors that can be assigned to a queue.
scale-up threshold—A threshold number of messages in a queue, which when met or exceeded, will cause message processors to be assigned to a queue.
scale-down threshold—A threshold number of messages in a queue, which when the queue length is at or below, will causes message processors to be removed from processing messages for a queue.

The instance processor manager 114 queries the length of the queue periodically and:
adds message processors if queue_length >scale-up_threshold and current_number_of_processors <max_processors_per_instance
removes message processors if queue_length <scale-down_threshold and current_number_of_processors >min_processors_per_instance

Note that other rules could be used when topic partitions do not change approximately in proportion to queue length. For example, in some embodiments, analysis may be performed on all messages in a queue to determine a distribution of topics in the message on the queue. Adding or removing message processors can be performed based on both the queue length and a topic partition distribution. For example, if an unusually high percentage of the message on the queue are all in a particular topic partition, there may be no need to add a large number of (or any) additional message processors as only a single message processor can process those messages. Thus, fewer message processors may be added in that case as compared to when similar numbers of messages are in the queue for each topic partition. Similarly, if a set of topic partitions have low numbers of messages as compared to other topic partitions for the queue, some embodiments may add a larger number of message processors as compared to when similar numbers of messages are in the queue for each topic partition.

Some embodiments may be configured to suppress adding or removing message processors, or to adjust how message processors are added or removed from a queue based on other external knowledge. For example, if it is known that a surge of messages having a particular partition topic identifier is expected, embodiments can suppress adding additional message processors as a surge of messages all having the same partition topic identifier may have little useful effect. Such knowledge may be obtained based on historical factors, machine learning, or other analysis.

In an alternative example, message processors may be added or removed based on importance of topic partitions. For example if a set of ‘important’ partition topic identifiers is identified in a set of messages, more message processors can be added than when the messages are deemed to have less important partition topic identifiers.

Automatic scale up/down helps use resources efficiently in a cluster environment.

Thus, as illustrated above, embodiments may implement cluster based FIFO queues divided by topic partitions that allows horizontal scale-out of a number of machines that host message processors and/or automatic scaling of message processors inside a single machine. This can be used where multiple queues are implemented and where topic partitions are accepted inside a given queue. Embodiments can be implemented where system require processing of messages received for a topic in a queue in a FIFO manner.

Using the embodiments described above, embodiments can also accomplish compression of messages processed by a work processor. In particular, given that the queue is FIFO based on time, once a lock is placed on a topic partition, embodiments can be implemented where only the most recent message of the topic partition will be processed, while all the older ones can be discarded for the topic partition. This kind of optimization results in “compressing” the queue by only processing the most relevant message for a topic partition in any given iteration and discarding the ones that are obsolete. Thus for example, in embodiments where it is desirable to only process messages with the latest state information, embodiments can quickly identify those messages and discard any others.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

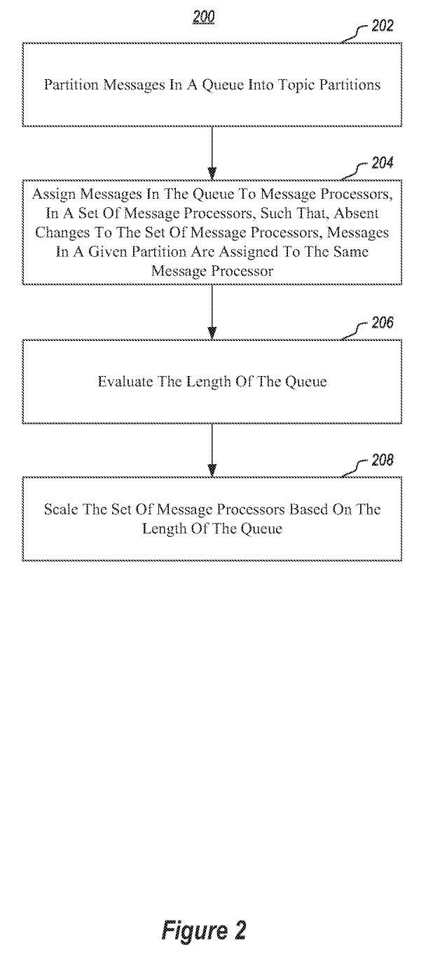

Referring now to FIG. 2, a method 200 is illustrated. The method 200 is a computer implemented method of managing queue message processors. The method 200 includes partitioning messages in a queue into topic partitions (act 202). The topic partitions are defined by partition topic identifiers derived from data or metadata for the messages.

The method 200 further includes assigning messages in the queue to message processors, in a set of message processors, such that, absent changes to the set of message processors, messages in a given partition are assigned to the same message processor (act 204). For example, the result of a hash of a partition topic identifier name modulo the number of message processors described previously is one example of an operation that may be used to assign messages to message processors.

The method 200 further includes, for the queue, evaluating the length of the queue (act 206). For example, the instance processor manager 114 can determine the number of messages on a queue.

The method 200 further includes scaling the set of message processors based on the length of the queue (act 208). For example, the method 200 may be practiced where evaluating the length of the queue results in a determination that the queue exceeds an upper limit threshold. In this embodiment, and as a result, the method 200 may further include scaling up a number of message processors in the set of message processors. Alternatively, the method 200 may be practiced where evaluating the length of the queue results in a determination that the queue is below a lower limit threshold. In this embodiment, and as a result, the method 200 may further include scaling down a number of message processors in the set of message processors.

As illustrated in the examples, above, the method 200 may be practiced where scaling the set of message processors is based on a minimum number of message processors that can be assigned to a queue. Alternatively or additionally, the method 200 may be practiced where scaling the set of message processors is based on a maximum number of message processors that can be assigned to a queue.

The method 200 may further include a message processor processing messages in a topic partition in a First In First Out (FIFO) fashion.

The method of 12, further comprising a message processor taking a lock on a topic partition when processing messages from the topic partition. Thus, even though one would expect that a locking mechanism might not be needed due to the assignment of a single message processor per partition topic identifier, embodiments herein could implement locking mechanisms when scaling up or scaling down message processors, changing the identification of message processors, or other changes to the message processors might result in multiple message processors being used to process messages from the same topic partition.

The 200 may be practiced where at least one partition topic identifier is inferred from data or metadata for the message. For example, in the example illustrated previously, even though a message only includes ‘teddy bears’ the partition topic identifier ‘stuffed animals’ could be inferred using various inference rules. Thus, inference rules may be used to identify a partition topic identifier name which is not directly included in data or metadata for a message.

The 200 may be practiced where at least one partition topic identifier is based on a hash of information derived from data or metadata for the messages. Thus, for example, a partition topic identifier may be a hash code as opposed to some textual string or other partition topic identifier.

The method 200 may be practiced where assigning messages in the queue to message processors includes computing h modulo j where the result is used to identify a message processor, where h defines a hash of a partition topic identifier identifier and j defines a total number of active message processors for the queue.

The method 200 may be practiced where the topic partitions are content topic partitions. A content partition topic identifier is based on content of a message to be processed or content of metadata associated with a message as opposed to a type of processing that should be performed on the message

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system, Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be et braced within their scope.

What is claimed is:

1. A computer system comprising:
one or more processors; and
one or more computer-readable media having stored thereon instructions that are executable by the one or more processors to configure the computer system to manage queue processors, including instructions that are executable to configure the computer system to perform at least the following:
partition messages in a queue into topic partitions, the topic partitions being defined by partition topic identifiers derived from data or metadata for the messages;
assign messages in the queue to message processors, in a set of message processors, such that, absent changes to the set of message processors, messages in a given partition are assigned to the same message processor such that a single processor is assigned to a given topic partition, and there is a single topic partition per partition topic identifier;
for the queue, evaluate the length of the queue; and
scale the set of message processors based on the length of the queue.

2. The computer system of claim 1, wherein evaluating the length of the queue results in a determination that the queue exceeds an upper limit threshold, and wherein the one or more computer-readable media further have stored thereon instructions that are executable by the one or more processors to configure the computer system to scale up a number of message processors in the set of message processors.

3. The computer system of claim 1, wherein evaluating the length of the queue results in a determination that the queue is below a lower limit threshold, and wherein the one or more computer-readable media further have stored thereon instructions that are executable by the one or more processors to configure the computer system to scale down a number of message processors in the set of message processors.

4. The computer system of claim 1, wherein scaling the set of message processors is based on a minimum number of message processors that can be assigned to a queue.

5. The computer system of claim 1, wherein scaling the set of message processors is based on a maximum number of message processors that can be assigned to a queue.

6. The computer system of claim 1, wherein the one or more computer-readable media further have stored thereon instructions that are executable by the one or more processors to configure the computer system to cause a message processor to process messages in a topic partition in a First In First Out (FIFO) fashion.

7. The computer system of claim 1, wherein the one or more computer-readable media further have stored thereon instructions that are executable by the one or more processors to configure the computer system to cause a message processor to take a lock on a topic partition when processing messages from the topic partition.

8. The computer system of claim 1, wherein at least one partition topic identifier is inferred from data or metadata for the message.

9. The computer system of claim 1, wherein at least one partition topic identifier is based on a hash of information derived from data or metadata for the messages.

10. The computer system of claim 1, wherein assigning messages in the queue to message processors comprises computing h modulo j where the result is used to identify a message processor, where h defines a hash of a partition topic identifier identifier and j defines a total number of active message processors for the queue.

11. The computer system of claim 1, wherein the topic partitions are content topic partitions.

12. A computer implemented method of managing queue message processors, the method comprising:
partitioning messages in a queue into topic partitions, the topic partitions being defined by partition topic identifiers derived from data or metadata for the messages;
assigning messages in the queue to message processors, in a set of message processors, such that, absent changes to the set of message processors, messages in a given partition are assigned to the same message processor, such that a single processor is assigned to a given topic partition, and there is a single topic partition per partition topic identifier;
for the queue, evaluating the length of the queue; and
scaling the set of message processors based on the length of the queue.

13. The method of 12, wherein evaluating the length of the queue results in a determination that the queue exceeds an upper limit threshold, and as a result, the method further comprising scaling up a number of message processors in the set of message processors.

14. The method of 12, wherein evaluating the length of the queue results in a determination that the queue is below a lower limit threshold, and as a result, the method further comprising scaling down a number of message processors in the set of message processors.

15. The method of 12, wherein scaling the set of message processors is based on a minimum number of message processors that can be assigned to a queue.

16. The method of 12, wherein scaling the set of message processors is based on a maximum number of message processors that can be assigned to a queue.

17. The method of 12, further comprising a message processor taking a lock on a topic partition when processing messages from the topic partition.

18. The method of 12, wherein at least one partition topic identifier is based on a hash of information derived from data or metadata for the messages.

19. The method of 12, wherein assigning messages in the queue to message processors comprises computing h modulo i where the result is used to identify a message processor, where h defines a hash of a partition topic identifier identifier and j defines a total number of active message processors for the queue.

20. A cluster comprising system comprising:
a front end, wherein the front end is configured to generate messages to be processed by the cluster computing system;
one or more queues, wherein the queues are configured to receive messages from the front end, wherein the queue is partitioned into topic partitions, the topic partitions being defined by partition topic identifiers derived from data or metadata for the messages;
a backend, wherein the backend comprises:
a plurality of virtual machines, wherein each of the virtual machines in the plurality of virtual machines hosts one or more message processors;
an instance processor manager, wherein the instance processor manager is configured to:
for a queue, assign messages in the queue to message processors, in a set of message processors, such that, absent changes to the set of message processors, messages in a given partition are assigned to the same message processor such that a single processor is assigned to a given topic partition, and there is a single topic partition per partition topic identifier;
for the queue, evaluating the length of the queue; and
scaling the set of message processors based on the length of the queue.
